(19) United States
(12) Patent Application Publication
(10) Pub. No.: US 2006/0114606 A1
(43) Pub. Date: Jun. 1, 2006

(54) Information recording apparatus and information recording method

(75) Inventor: Naoki Ide, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Shinagawa-ku (JP)

(21) Appl. No.: 11/262,793

(22) Filed: Nov. 1, 2005

(30) Foreign Application Priority Data
Nov. 12, 2004 (JP) 2004-328394

(51) Int. Cl. G11B 5/127

(52) U.S. Cl. 360/125

(57) ABSTRACT

Magnetic recording is performed by a magnetic field lower than a coercive force without considerably changing the structure of a magnetic head and the vicinity thereof. When recording is performed by applying a magnetic field to a magnetic recording layer of a recording medium using a magnetic head, the electric field is generated in the magnetic recording layer so that the coercive force thereof is decreased. Accordingly, magnetization is recorded by a lower magnetic field than an intrinsic coercive force of the magnetic recording layer. In order to generate the electric field, a power source is connected to magnetic pole layers of a longitudinal magnetic recording head (or to a magnet pole layer of a perpendicular magnetic recording head and a conductive layer of a recording medium thereof).

### CROSS REFERENCES TO RELATED APPLICATIONS

The present invention contains subject matter related to Japanese Patent Application JP 2004-328394 filed in the Japanese Patent Office on Nov. 12, 2004, the entire contents of which are incorporated herein by reference.

### BACKGROUND OF THE INVENTION

1. Field of the Invention

The present invention relates to an information recording apparatus using a recording head, such as a magnetic head, which performs magnetic field modulation, and to an information recording method.

2. Description of the Related Art

In information recording methods using a magnetic tape, a magnetic disc, and the like, a magnetic field is generated in a particular area of a magnetic recording film by using a magnetic recording head which generates magnetic fields having different directions depending on information, so that the information is recorded by changing the direction of the magnetization in the above particular area.

In the information recording method using the magnetization of a magnetic material as described above, the limitation of the recording density of information is determined by the width of a magnetic domain wall generated between adjacent areas in which different magnetizations are recorded. In addition, it has been known that the width of this magnetic domain wall has an inverse relationship with the coercive force of a magnetic recording medium forming a magnetic film. That is, in order to decrease the width of the magnetic domain wall, it is necessary to increase the coercive force. Hence, in magnetic information recording, in order to record information at a high density, it is necessary to have a magnetic medium having a high coercive force.

In addition, when magnetic recording is performed for a recording medium having a high coercive force, a magnetic head may be required which is capable of generating a high magnetic field in accordance with the coercive force.

However, it has been known that the intensity of a magnetic field generated by a currently available recording head used for magnetic recording has a limitation. Accordingly, as long as currently available recording heads are used, the intensity of the magnetic field generated thereby may not be able to exceed the coercive force in the future.

In consideration of the situations described above, in the magnetic information recording method, a method may be required in which magnetization is recorded by a magnetic field lower than the coercive force of a recording medium.

As a method for realizing the above recording method, it is desirable to develop a method in which the coercive force is temporarily decreased in recording so that magnetization is recorded at a low magnetic field.

As one example of the method described above, heat assisted magnetic recording may be mentioned. In this method, by applying heat to a magnetic material in recording, the coercive force is temporarily decreased (see Japanese Unexamined Patent Application Publication No. 2-42611).

In addition, as a method for applying heat, for example, there may be mentioned a method using light or laser light, a method supplying hot wind, and a method using Joule heat.

### SUMMARY OF THE INVENTION

The heat assisted magnetic recording is realized when the following two conditions are satisfied.

(1) In order to maintain a transfer rate, high speed thermal conduction can be performed.

(2) Heat distribution is allowed to occur locally at which magnetic recording is carried out.

The condition (2) is a condition for preventing a place having a coercive force which is decreased by heat application from influencing places other than that at which magnetic recording is performed.

In view of the points described above, since being considerably inferior to related magnetic recording in terms of the rapid heat conduction described in the above (1), a method using heat conduction, such as a method supplying hot wind or a method using Joule heat, may not be mentioned as a candidate used for the heat assisted recording.

On the other hand, a method using laser light is superior to other methods in terms of a time necessary for conduction of energy. Hence, the above method using laser light has been regarded as a promising practical candidate.

As a practical method for irradiating a recording medium with laser light, for example, there may be mentioned a method in which laser light is converged using a lens, or a method in which a front end of a laser emission aperture of an optical pickup is inserted into a fiber.

In the methods of laser irradiation as described above, a first problem is that an optical pickup mechanism which allows laser light to pass is necessary besides a magnetic recording head which has been used for generating magnetic fields. As a result, in the case in which light is converged by a lens, at least one object lens is necessary, and a control system may also be required to control focusing and tracking of this lens.

In addition, when a fiber is used, at least a control system is necessary which maintains the fiber in a predetermined state and maintains a constant distance between the fiber and a magnetic film. Hence, only for assistance in recording and not for actual recording, besides a mechanism used for recording, an additional mechanism having similar complexity thereto is necessarily used.

Next, it is considered how the above optical pickup system and the magnetic recording head are disposed in an actual recording system. First, it is considered whether the above mechanism and the recording head are formed integrally or separately.

When the pickup mechanism and the recording head are separately formed, it becomes very difficult to satisfy the condition in which the recording area at which recording is performed by a magnetic field is allowed to coincide with the position of an optical spot at which heat assistance is performed. In this case, the above condition may only be satisfied by the structure in which the recording head and the pickup mechanism are disposed to face each other with a magnetic recording medium provided therebetween. Hence, a method for detecting a recording position of the recording head at the pickup mechanism side may be required, and as a result, it is necessary that a new control technique be further developed.

On the other hand, in the case in which the pickup mechanism and the recording head are integrally formed, it is necessarily considered how to additionally dispose a lens and a fiber in combination with the recording head. Furthermore, when the pickup mechanism is additionally disposed on the recording head, the structure of a related floating type recording head is to be considerably changed in consideration of lift and the like. In addition, even when the pickup mechanism and the recording head are integrated, it is still difficult that the optical spot is formed to have a size approximately equivalent to the magnetic recording area and is allowed to coincide therewith as described above.

As described above, in order to decrease the coercive force of a magnetic recording film with assistance of heat or the like, an additional mechanism such as the above optical pickup mechanism, which is not directly relating to recording, is inevitably used for the magnetic recording head, and in practice, it is very difficult to realized the addition of the new mechanism as described above.

Hence, without adding a new mechanism such as an optical pickup mechanism in the vicinity of a magnetic recording head and/or without performing considerable mechanical modification thereof, development of a new function in which the coercive force of a magnetic recording layer is temporarily decreased is increasingly important.

Accordingly, it is desirable to have a new recording method capable of effecting magnetic recording by a magnetic field lower than the coercive force without considerably changing the structure of a magnetic recording head.

An information recording apparatus according to an embodiment of the present invention includes: a recording head generating magnetic fields having different directions in accordance with information; a recording medium having a magnetic recording layer recording magnetizations in accordance with the magnetic fields; and electric field generation means for generating an electric field in the magnetic recording layer when magnetic recording is performed for the magnetic recording layer by the recording head, the electric field generation means having a voltage source.

In addition, the recording head described above is a longitudinal magnetic recording head having two magnetic pole layers which generate a leakage magnetic field, and the two magnetic pole layers are formed as a first conductive portion and a second conductive portion, which are insulated from each other with an insulating portion. The two magnetic pole layers formed as the first conductive portion and the second conductive portion are connected to a positive electrode side and a negative electrode side, respectively, of the voltage source.

Alternatively, the recording head is a perpendicular magnetic recording head having a magnetic pole layer formed as a conductive portion, and the recording medium further has a substrate and a conductive layer including a conductive material, the conductive layer being provided between the magnetic recording layer and the substrate. In addition, the magnetic pole layer formed as the conductive portion of the recording head and the conductive layer of the recording medium are connected to a positive electrode side and a negative electrode side, respectively, of the voltage source.

A method for recording information, according to an embodiment of the present invention, has the step of generating an electric field in a magnetic recording layer of a recording medium when magnetic recording is performed for the recording medium having the magnetic recording layer by generating magnetic fields having different directions in accordance with information using a recording head, the magnetic recording layer recording magnetizations in accordance with the magnetic fields.

The recording head described above is a longitudinal recording head in which two magnetic pole layers generating a leakage magnetic field are separated with an insulating portion to form a first conductive portion and a second conductive portion, the two magnetic pole layers are connected to a positive electrode side and a negative electrode side of a voltage source so as to generate an electric field between the two magnetic pole layers, and a leakage electric field of the electric field is applied to the magnetic recording layer.

Alternatively, the recording head described above is a perpendicular recording head in which a magnetic pole layer is formed as a conductive portion, the recording medium further has a substrate and a conductive layer including a conductive material, the conductive layer being provided between the magnetic recording layer and the substrate, the magnetic pole layer formed as the conductive portion of the recording head and the conductive layer of the recording medium are connected to a positive electrode side and a negative electrode side, respectively, of a voltage source so as to generate an electric field between the magnetic pole layer and the conductive layer, and the electric field generated therebetween is applied to the magnetic recording layer.

According to the above embodiments of the present invention, the electric field is generated in the magnetic recording layer of the recording medium, so that the coercive force of the recording layer is decreased. Hence, magnetization can be recorded by a lower magnetic field than an intrinsic coercive force of the magnetic recording layer.

According to the embodiments of the present invention, when magnetization is recorded on the magnetic recording layer of the recording medium by the recording head, the electric field is generated in the magnetic recording layer, thereby decreasing the coercive force thereof. Hence, the magnetization can be recorded at a magnetic field lower than the intrinsic coercive force of the magnetic recording layer. Consequently, even when a recording medium having a high coercive force is used for high density recording, without using a recording head generating a significantly high magnetic field, high density magnetic recording can be effectively realized.

Furthermore, in order to generate the electric field, the structure in which the voltage source is connected to the magnetic pole layers (or the magnetic pole layer and the conductive layer of the recording medium) may only be formed; hence, for example, unlike the case of heat assisted recording using laser light, it is not necessary to provide the optical pickup mechanism, to perform considerable change in structure of the magnetic head, and to perform the control thereof. As a result, the magnetic recording apparatus according to the embodiment of the present invention can be easily realized, and hence a highly practical magnetic recording apparatus can be effectively provided. For example, the magnetic recording apparatus described above can be easily used as a hard disc drive.

### BRIEF DESCRIPTION OF THE DRAWINGS

FIG. 1 is a schematic perspective view showing a hard disc device according to an embodiment of the present invention;

FIG. 2 is a schematic cross-sectional view of a longitudinal magnetic recording head of an embodiment;

FIG. 3 is a schematic cross-sectional view of a perpendicular magnetic recording head of an embodiment;

FIG. 4 is a cross-sectional view of a disc layer structure of an embodiment;

FIG. 5 is a cross-sectional view of a disc layer structure of an embodiment;

FIG. 6 is a cross-sectional view of a disc layer structure of an embodiment;

FIG. 7 is a cross-sectional view of a power connection structure of a conductive layer of a disc of an embodiment; and

FIG. 8 is a cross-sectional view of a power connection structure of a conductive layer of a disc of an embodiment.

### DESCRIPTION OF THE PREFERRED EMBODIMENTS

Hereinafter, with reference to a hard disc drive as an example, embodiments of the present invention will be described in the following order.

1. Magnetic Recording with Electric Field Application

2. Structure of a Hard Disc Device

3. Example Using a Longitudinal Magnetic Recording Head

4. Example Using a Perpendicular Magnetic Recording Head

1. Magnetic Recording with Electric Field Application

In this embodiment, in order to perform magnetic recording by a magnetic field lower than the coercive force of a recording medium (magnetic disc), in magnetic recording, the coercive force is decreased by applying an electric field to the recording medium.

As described above, although there have been still various problems when magnetic recording is performed at a magnetic field lower than the coercive force using a heat assisted recording method, the above problems can be solved by an electric field application method. Hereinafter, the concept of this embodiment will be described.

First, among components forming a magnetic recording head, it is considered whether components used for the purpose other than the generation of a recording magnetic field are present. It is understood that the structure of the magnetic recording head is basically formed of the following two components.

1. A Magnet which Applies a Magnetic Field to a Recording Area of a Recording Layer

2. A Coil which Generates Magnetic Flux in the Magnet

Currently, the magnet is responsible for increasing a magnetic field at a specific position of the recording medium on which recording is to be performed by concentrating magnetic flux at the front ends of the magnet, the magnetic flux being generated by applying current to the coil.

Accordingly, without considerably changing the structure of this magnet, when the coercive force of the magnetic recording layer of the recording medium can be temporarily decreased, magnetic recording can be performed at a magnetic field lower than the coercive force without modifying a main body of the magnetic head.

As a method for effectively using this magnet, for example, a method may be mentioned in which since the magnet is formed of a soft magnetic metal such as iron, the electric field is generated from this magnet besides the magnetic field. In order to realize this method, the structure may be formed in which the magnet is connected to an exterior voltage source which is different from the coil. However, even when an attempt is made to generate the electric field by simply connecting the magnet to the exterior power source, the two ends of this voltage source do not form a circuit in this case, and hence it is not sufficient to generate the electric field. Accordingly, it is necessary to form the circuit from this voltage source.

The first solution is for the case of a longitudinal magnetic recording head.

In the longitudinal magnetic recording head, the two ends of a magnet having a horseshoe shape are formed to have a very small gap therebetween, and a leakage magnetic field of a magnetic field generated therebetween is recorded on a recording film. Hence, also in generating the electric field, the structure may be formed in which a leakage electric field of the electric field generated between the two ends of the magnet is supplied to the recording film.

In order to realize the structure described above, after the magnet having a horseshoe shape is cut into two magnet pole layers, and an insulating material is provided therebetween, the two ends of the exterior voltage source may be connected to the respective magnet pole layers thus separated with exterior electrodes provided therebetween so as to obtain a potential difference. By the structure as described above, the front ends of the magnet pole layers form a capacitor structure, and thereby the electric field is generated, so that a leakage electric field thereof may have an influence on the recording medium.

The second solution is for the case of a perpendicular magnetic recording head. In the perpendicular magnetic recording head, in addition to a magnetic pole layer called a main magnetic pole layer for generating a magnetic field, a magnetic layer called a soft magnetic layer is prepared under the recording layer at the recording medium side. Hence, in generation of the magnetic field, magnetic flux generated from the main magnetic pole layer is allowed to reach the soft magnetic layer before it is scattered, so that the magnetic field thus generated can be effectively used in the same direction.

Hence, in order to realize the effect similar to that described above for the generation of the electric field, in addition to the magnet pole layer generating the electric field, an electrically conductive layer may be provided under the recording layer at the recording medium side. This electrically conductive layer may be different from the soft magnetic layer; however, since being generally formed from an electrically conductive material, the soft magnetic layer may also be used as the electrically conductive layer. In the case in which a layer different from the soft magnetic layer is used, a non-magnetic material such as aluminum or copper may also be used for the electrically conductive layer.

Whether the electrically conductive layer is formed independently from the soft magnetic layer or not is determined depending on the purpose whether the efficiency of the electric field is improved by using two different layers or the cost is decreased by decreasing the number of layers. The electrically conductive layer thus provided is connected to the other end of the exterior voltage source via an electrode. By the structure as described above, a capacitor structure is formed between the magnetic pole layer and the electrically conductive layer, and as a result, the exterior voltage source and this capacitor form a loop structure. Hence, the electric field generated thereby may influence the recording layer.

In addition, in both cases of the longitudinal magnetic recording head and the perpendicular magnetic recording head, it is to be considered how to decrease the coercive force by applying the electric field to a recording layer which is formed of a ferromagnetic material. In other words, the coercive force of the ferromagnetic recording layer is to be decreased by application of the electric field. Since most common ferromagnetic materials such as iron, cobalt, and nickel are all conductive materials, the electric field is not generated therein due to electrostatic shielding. That is, it is not expected that the effect is obtained even when the electrostatic field is applied to the ferromagnetic material as described above. However, when the ferromagnetic material is made from a semiconductor or an insulating material, the electric field may penetrate into this ferromagnetic material. That is, it is proper that the recording layer be a ferromagnetic semiconductor layer or a ferromagnetic insulating layer.

Hereinafter, the structure of a hard disc device will be described, and then, as the recording head, the case in which the longitudinal magnetic recording head is used and the case in which the perpendicular magnetic recording head is used will be described.

2. Structure of Hard Disc Device

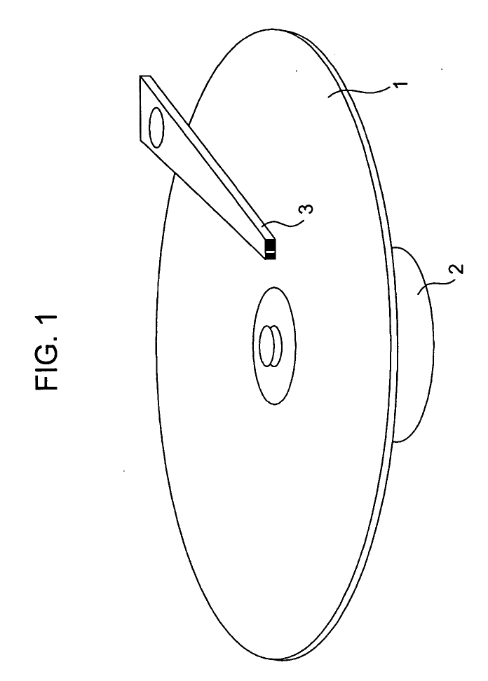

FIG. 1 is a schematic view showing a hard disc device according to this embodiment.

As shown in FIG. 1, the hard disc device is formed of a hard disc (magnetic disc) 1 used as a recording medium, a spindle motor 2, and a recording head 3.

The hard disc 1 functioning as a recording medium is formed of a substrate of glass, aluminum or the like, and a thin film of a ferromagnetic material, such as Fe, or an alloy of Fe, Co, or Pt, provided on the substrate. On this thin film, a helical or concentric recording region (recording track) is provided, the direction of magnetization on this recording region represents information.

In addition, the spindle motor 2 functions to rotationally drive the hard disc 1. As a result, for example, in the helical recording region, the hard disc 1 provided under the floating recording head 3 continuously rotates.

The recording head 3 changes the magnetic field generated therefrom with time so as to continuously change the magnetization of an area of the recording region located under the rotating head 3, and this change is recorded as information with time. As described above, information is recorded on the hard disc 1.

3. Case of Longitudinal Magnetic Recording Head

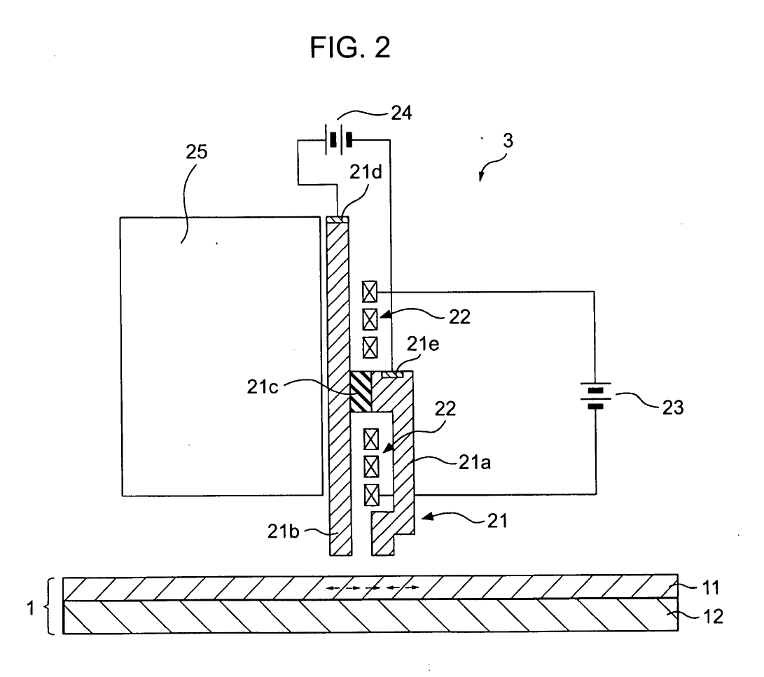

FIG. 2 shows the case in which a longitudinal magnetic recording head is used as the recording head 3.

FIG. 2 is a schematic cross-sectional view of the recording head 3 used for longitudinal magnetic recording taken along a line direction of the hard disc 1, that is taken along a line parallel to the track direction.

The recording head 3 for longitudinal magnetic recording is formed of a ring head 21, a coil 22, a current source 23, a voltage source 24, and a slider 25.

The hard disc 1 is composed of a substrate 12 formed of a glass or the like and a recording layer 11 provided thereon used as a magnetic layer.

The ring head 21 has the structure in which a conductive portion 21a and a conductive portion 21b are separated with an insulating portion 21c provided therebetween. The front ends of the conductive portions 21a and 21b function as magnetic poles of the ring head 21.

The coil 22 is helically or concentrically wound around the ring head 21 in a direction perpendicular to the plane of the figure. The current source 23 is connected to the coil 22, and a magnetic field generated from the ring head 21 in accordance with the direction of current from the current source 23 is applied to the recording layer 11 of the hard disc 1, so that magnetic recording is performed.

The recording head 3 composed of the ring head 21 and the coil 22 as described above is connected to the slider 25 together with a GMR head (not shown) for reproduction and is formed to float above the hard disc 1 with an appropriate gap therefrom.

In addition, the hard disc 1 functions as a magnetic disc in which magnetizations are recorded in directions parallel to the surface of the substrate 12 as shown by arrows in the recording layer 11.

The points of the ring head 21 of this recording head 3 different from a common ring head are as follows. That is, the magnetic pole layers are formed of the conductive portions 21a and 21b separated by the insulating portion 21c, and in addition, the positive electrode and negative electrode of the voltage source 24 are connected to an electrode 21d formed on the conductive portion 21b and an electrode 21e formed in the conductive portion 21a, respectively. The rest of the structure of the ring head 21, the scale of the length, the arrangement of the coil and the like may be the same as those of the common ring head.

For example, as is a known thin film head structure, the depth of the magnetic pole layer of the ring head 21 of this embodiment, that is, the width of the magnetic pole layer may be set to 0.31 μm, the lateral width of the magnetic pole layer, that is, the thickness thereof may be set to 2.2 μm, and the length of the gap may be set to 0.1 μm.

That is, the recording head 3 of this embodiment having the thin film head structure as described above can be formed by the following steps. That is, the magnetic pole layers of this thin film head are formed of conductors (conductive portions 21a and 21b), an insulating material (insulating material 21c) is provided between the magnetic pole layers for electrical insulation therebetween, and the two magnetic pole layers, that is, the conductor portions 21a and 21b, are connected to the voltage source 24.

Recording of information using the recording head 3 shown in FIG. 2 is performed when the voltage source 24 and the current source 23 are simultaneously switched on.

When current, which has a polarity in accordance with information to be recorded, for generating the magnetic field is supplied into the coil 22 from the current source 23, and when the electric field is applied to the hard disc 1 by applying the voltage from the voltage source 24 synchronously with the supply of the current, the coercive force of the recording layer 11 is decreased. That is, the front ends of the conductive portions 21a and 21b, that is, the magnetic pole layers, make a capacitor structure which generates the electric field, and a leakage electric field thereof is applied to the recording layer 11, so that the coercive force thereof is decreased. As a result, the recording of magnetization can be realized at a low magnetic field.

In addition, in order to decrease the coercive force of the recording layer 11 by applying the electric field, it is necessary that the recording layer 11 be formed of a ferromagnetic semiconductor or a ferromagnetic insulating material. The above recording layer 11 will be collectively described in the following case in which a perpendicular magnetic recording head is used.

4. Case of perpendicular magnetic recording head Next, the case in which a perpendicular magnetic recording head 31 is used as the recording head 3 will be described.

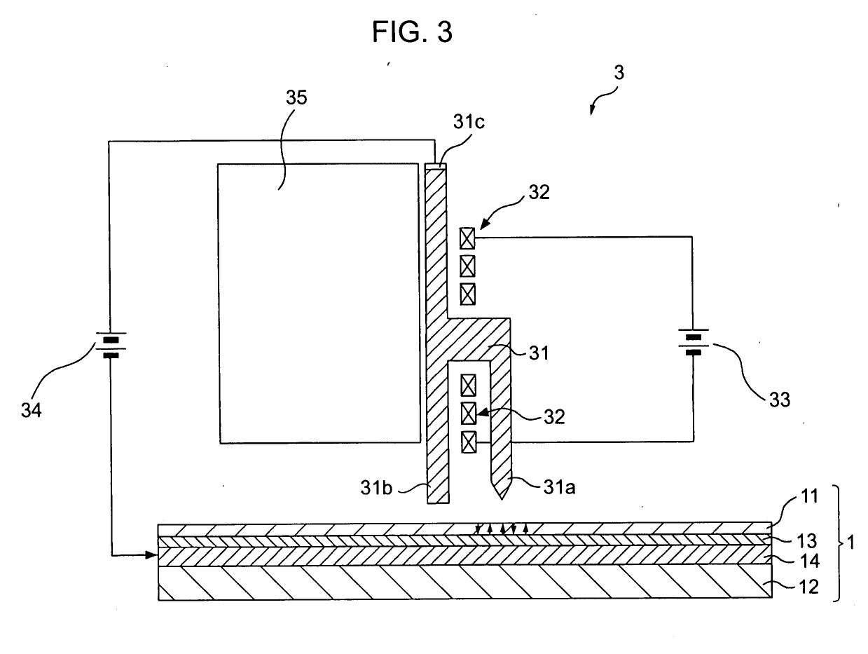

FIG. 3 is a schematic cross-sectional view of the recording head 3 used for perpendicular magnetic recording taken along a line direction of the hard disc 1, that is, taken along a line parallel to the track width direction (perpendicular to the radius direction).

In this case, the recording head 3 is formed of the perpendicular magnetic recording head 31 composed of a main magnetic pole layer 31a and an auxiliary magnetic pole layer 31b, a coil 32, a current source 33, a voltage source 34, and a slider 35.

The perpendicular magnetic recording head 31 is formed of a conductor, and the main magnetic pole layer 31a and the auxiliary magnetic pole 31b are formed as front ends of the conductor.

The coil 32 is helically or concentrically wound around the perpendicular magnetic recording head 31 in a direction perpendicular to the plane of the figure. The current source 33 is connected to the coil 32, and when a magnetic field generated from the perpendicular magnetic recording head 31 in accordance with the direction of current supplied from the current source 33 is applied to the recording layer 11 of the hard disc 1, magnetic recording is performed.

The recording head 3 formed of the perpendicular magnetic recording head 31 and the coil 32 as described above is connected to the slider 35 together with a GMR head for reproduction (not shown) and the like and is formed to float above the hard disc 1 with an appropriate gap therefrom.

The hard disc 1 functions as a magnetic disc in which magnetizations are recorded in directions perpendicular to the surface of the substrate 12 as shown by arrows in the recording layer 11.

The hard disc 1 is formed of the recording layer 11, a soft magnetic layer 13, and the substrate 12 laminated in that order from the top. The recording layer 11 is a layer recording the magnetization, and the soft magnetic layer 13 is an auxiliary layer provided for forming a loop of magnetic lines in perpendicular magnetic recording.

In addition, particularly in this embodiment, as shown in the figure, under the soft magnetic layer 13 (or on the soft magnetic layer 13), a conductive layer 14 is provided.

Since being generally formed of a material having electrically conductive properties, such as a magnetic metal, the soft magnetic layer 13 may also be used as the conductive layer 14. However, in the above case, it is necessary that the electrical conductivity of the soft magnetic layer 13 be sufficiently high.

The points of the recording head 3 of this embodiment different from a common perpendicular magnetic recording head are as follows. That is, in this embodiment, the main magnetic pole layer 31a (an electrode 31c on the perpendicular magnetic recording head 31) is connected to one end of the voltage source 34, and in addition, the conductive layer 14 (or the soft magnetic layer 13 when it is also used as the conductive layer) of the hard disc 1 is connected to the other end of the voltage source 34.

The rest of the structure, the scale of the length, the arrangement of the coil and the like may be the same as those of the common perpendicular magnetic recording head.

For example, a currently known perpendicular magnetic recording head has the following structure.

The cross-sectional view of the main magnetic pole layer has a trapezoidal shape and the front portion thereof has an area of approximately 100 nm square.

The cross-sectional view of the auxiliary magnetic pole layer has a plate shape having a thickness of 2 μm and a depth of 30 μm or more.

The distance between the magnetic pole layers is 10 μm.

The height of the main magnetic pole layer is approximately 20 μm.

Accordingly, when the head having the structure described above is connected to one end of the exterior voltage source 34, the perpendicular magnetic recording head 31 of this embodiment can be formed.

Recording of information using this recording head 3 shown in FIG. 3 is performed by simultaneously switching on the voltage source 34 and the current source 33.

When current, which has a polarity in accordance with information to be recorded, for generating the magnetic field is supplied from the current source 33 into the coil 32, the voltage is synchronously applied from the voltage source 34. In this case, the main magnetic pole layer 31a and the conductive layer 14 form a capacitor structure, and as a result, the voltage source 34 and this capacitor form a loop structure. Hence, the electric field is generated from the main magnetic pole layer 31a to the conductive layer 14, and thereby the coercive force of the recording layer 11 is decreased. Consequently, recording of magnetization can be realized at a low magnetic field.

Next, the layer structure of the hard disc 1 will be described. In the case of this embodiment, a layer functioning as a conductor is necessarily formed in the hard disc 1, and for this purpose, the layer structure formed of the soft magnetic layer 13 and the conductive layer 14 sandwiched by the recording layer 11 and the substrate 12 may be mentioned as shown in FIG. 3.

When this conductive layer 14 and the soft magnetic layer 13 are formed of different layers, for forming the conductive layer 14, a material, such as aluminum, copper, gold, or silver, having good conductivity, may be selected regardless whether it is a magnetic or a non-magnetic material.

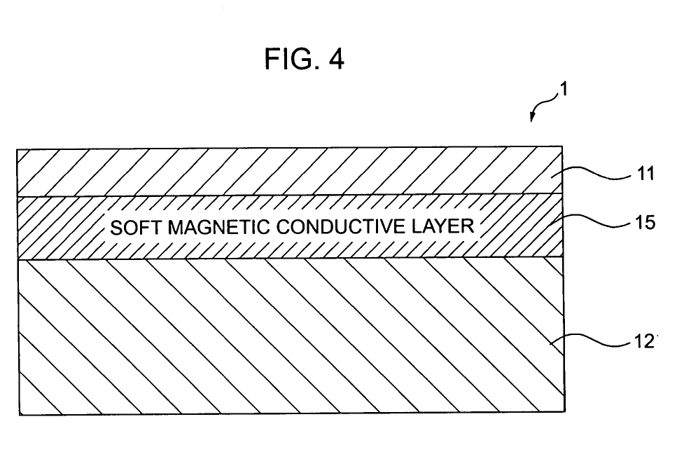

In addition, as shown in FIG. 4, there may also be mentioned the structure composed of the recording layer 11 and the substrate 12 with a soft magnetic conductive layer 15 provided therebetween. That is, since being generally formed of a conductive material, the soft magnetic layer may also be used as the conductive layer.

Whether the conductive layer 14 and the soft magnetic layer 14 are separately formed as shown in FIG. 3 or the soft magnetic conductive layer 15 is formed as shown in FIG. 4 may be determined depending on the purpose whether the efficiency of the electric field is improved by the structure shown in FIG. 3 or the cost is decreased by decreasing the number of the layers.

Next, the case in which the electric field is actually applied to the recording layer 11 formed of a ferromagnetic material will be described. The following description of the recording layer 11 of the ferromagnetic material may also be applied to the case in which the longitudinal magnetic recording head shown in FIG. 2 is used.

In examples of this embodiment, the electric field is applied to the recording layer 11 of a ferromagnetic material as described above; however, since most popular ferromagnetic materials such as iron, cobalt, or nickel are all conductive materials, the electric field is not generated inside due to electrostatic shielding. That is, even when the electrostatic field is applied to the ferromagnetic material as described above, it is not expected that the effect described above is obtained.

However, when a ferromagnetic material is formed from a semiconductor or an insulating material, the electric field may penetrate this ferromagnetic material. In the case described above, it is necessary that the semiconductor be an intrinsic semiconductor or a semiconductor containing a small amount of impurity so as not to cause electrostatic shielding. As the semiconductor having ferromagnetic properties described above, a semiconductor (In, Mn) As prepared by highly heavily doping of III-V compound semiconductor InAs with Mn using a molecular beam epitaxial growth method was discovered in 1989 (reference: H Munekata, H Ohno, S. von Molnar, A. Segmuller, and L. L. Chang, Phys. Rev. Lett. 63, 1849 (1989)).

The semiconductor having ferromagnetic properties as described above is called a ferromagnetic semiconductor or a diluted magnetic semiconductor and is obtained by replacing some of atoms forming a non-magnetic compound semiconductor with magnetic ions. As a method representing the above semiconductor, a compound which is obtained by replacing some of ions A of a non-magnetic compound semiconductor AB with ions C is represented by (A, C) B.

At the beginning, in this type of semiconductor, ferromagnetic transition occurs at a ultra low Curie temperature; however, after then, (Ga, Mn) As formed by doping of GaAs, another III-V compound semiconductor, with Mn was discovered in which the ferromagnetic transition occurs at a Curie temperature of approximately 100 K (reference: H. Ohno, A. Shen, F. Matsukura, A. Oiwa, A. Endo, S. Katsumoto and Y. Iye, “(Ga, Mn) As: A new diluted magnetic semiconductor based on GaAs,” Appl. Phys. Lett., vol. 69 (3), pp. 363-365, 15 Jul., 1996).

Recently, in (Ga, Mn) N formed by doping of III-V compound semiconductor GaN with Mn, it was discovered that the ferromagnetic transition occurs at room temperature (reference: S. Sonoda, S. Shimizu, T. Sasaki, Y. Yamamoto and H. Hori, J. Cryst. Growth. 237, 1358 (2002)).

In addition to the III-V compound semiconductors, of II-VI compound semiconductors, it was also discovered that (Zn, Co) 0, (Zn, V) 0, (Zn, Cr) Te and the like exhibit ferromagnetic properties at room temperature. The following are references.

(1) H. Saeki, H. Tabata and T. Kawai, Solid State Commun. 120, 439 (2001), and

(2) H. Saito, V. Zayets, S. Yamagata and K. Ando, PASPS-8 abstract (2002).

In addition, in order to decrease the coercive force by application of the electric field, the ferromagnetic material used for the recording film necessarily has a property in which the coercive force is decreased by electric field application, and among the semiconductors described above, semiconductors having the above property have been disclosed in the following references by way of example.

(1) H. Ohno, D. Chiba, F. Matsukura, T. Omiya, E. Abe, T. Dietl, Y. Ohno, and K. Ohtani, “Electric-field control of ferromagnetism,” Nature, Vol. 408, No. 6815, pp. 944 to 946, 21/28 Dec., 2000.

(2) D. Chiba, M. Yamanouchi, F. Matsukura, E. Abe, Y. Ohno, K. Ohtani, and H. Ohno, “Electric Field Effect on the Magnetic Properties of III-V Ferromagnetic Semiconductor (In, Mn) As and ((Al), Ga, Mn) As,” Journal of Superconductivity, 16, Issue 1, pp. 179 to 182, February 2003.

In the above references, as the ferromagnetic semiconductor, (In, Mn) As has been disclosed. In this semiconductor, when an electric field of approximately 1.5 V/10 nm is applied, the coercive force is decreased, and as a result, the magnetization required for the magnetic transition is decreased to approximately one fifth. That is, by application of the electric field, the coercive force is decreased. Hence, in the ferromagnetic semiconductor described above, it is believed that by applying the electric field, the recording magnetic field required for magnetic recording can be considerably decreased.

In the above references, applications relating to ferromagnetic semiconductor memories have been primarily described by way of example; however, also in a magnetic disc memory, when the ferromagnetic semiconductor as described above is used for a recording film, and when the electric field can be temporarily applied to the recording film, the same effect, that is, the effect of temporarily decreasing the coercive force can be expected.

Accordingly, for example, in the layer structure shown in FIGS. 3 and 4, when the recording layer 11 is a ferromagnetic insulating recording layer or a ferromagnetic semiconductor layer, a temporary decrease in coercive force can be effectively performed.

In addition, when the ferromagnetic semiconductor recording layer is used, a ferromagnetic semiconductor formed by replacing some of atoms forming a non-magnetic compound semiconductor with magnetic ions is preferably used.

As the ferromagnetic semiconductor described above, for example, (In, Mn) As, (Ga, Mn) As, (Ga, Mn) N, (Zn, Co) O, (Zn, V) O, and (Zn, Cr) Te may be mentioned.

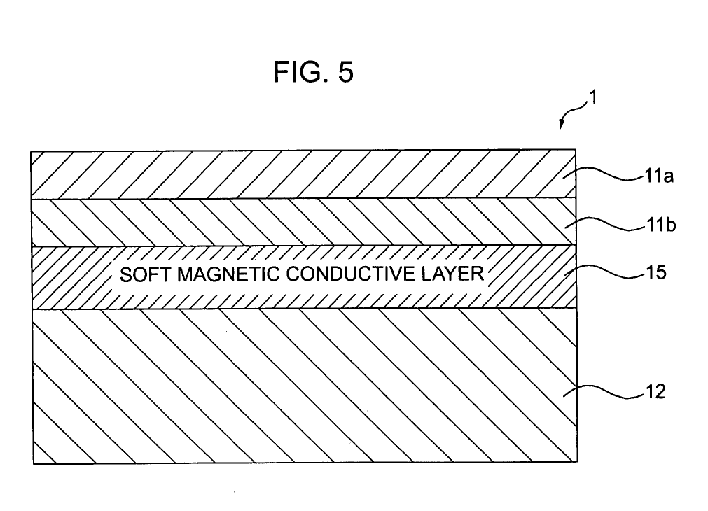

In addition, as shown in FIG. 5, the recording layer 11 may also have another layer structure formed of a ferromagnetic recording layer 11a and a ferromagnetic semiconductor layer 11b. That is, as the recording layer 11, on the soft magnetic conductive layer 15, the ferromagnetic semiconductor layer 11b and the ferromagnetic conductive layer 11a are formed in that order from the bottom.

In the case described above, the electric field effect is not generated in the ferromagnetic recording layer 11a; however, when the coercive force of the ferromagnetic semiconductor layer 11b is decreased by the electric field effect, the coercive force of the ferromagnetic recording layer 11a is also decreased by an exchange coupling effect.

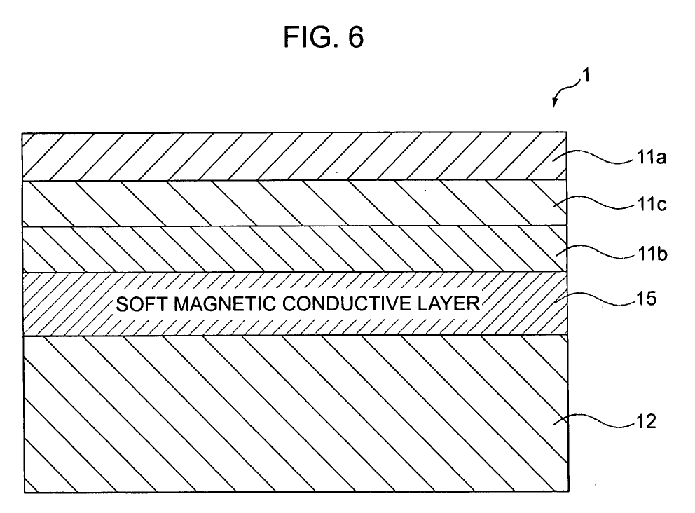

Furthermore, as shown in FIG. 6, the recording layer 11 may also have another layer structure formed of the ferromagnetic recording layer 11a, a non-magnetic layer 11c, and the ferromagnetic semiconductor layer 11b. That is, as the recording layer 11, on the soft magnetic conductive layer 15, the ferromagnetic semiconductor layer 11b, the non-magnetic layer 11c, and the ferromagnetic conductive layer 11a are formed in that order from the bottom.

Also in the case described above, the electric field effect is not generated in the ferromagnetic recording layer 11a; however, when the coercive force of the ferromagnetic semiconductor layer 11b is decreased by the electric field effect, this change in magnetic field is propagated as the magnetization to the non-magnetic layer 11c, and by a so-called magnetostatic-effect assist, the coercive force of the ferromagnetic recording layer 11a is also decreased.

In the structures shown in FIGS. 5 and 6, the ferromagnetic recording layer 11a may be formed of a ferromagnetic compound containing a ferromagnetic metal selected from Fe, Co, Ni, and Pt or an alloy thereof. In addition, the ferromagnetic semiconductor layer 11b may be formed of an insulating material or a semiconductor, containing particles of the ferromagnetic compound or the alloy.

In the case shown in FIG. 3 in which the perpendicular magnetic recording head 31 is used, it is necessary that the conductive layer 14 (or the soft magnetic conductive layer 15 shown in FIG. 4 or the like) be electrically connected to the voltage source 34.

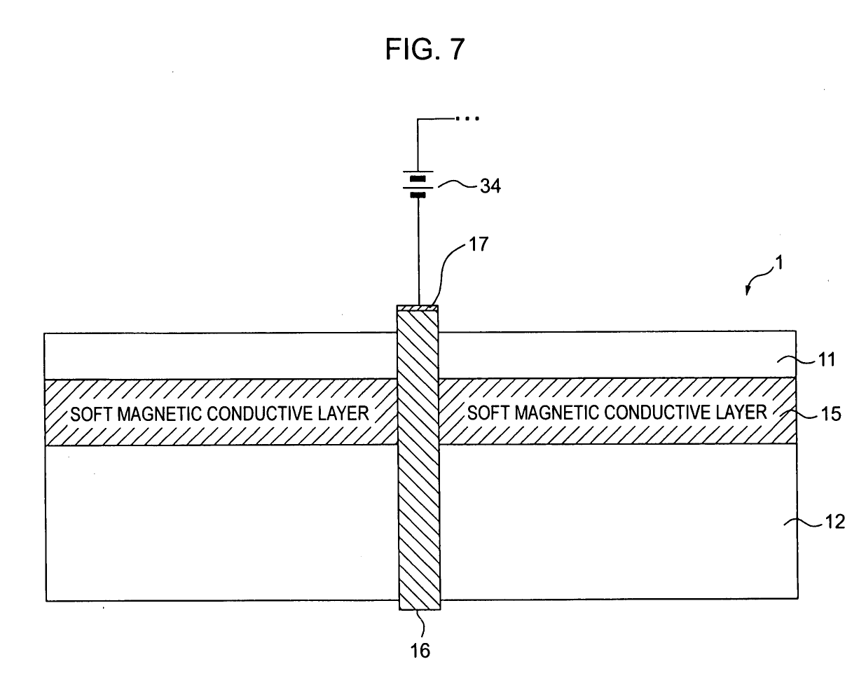

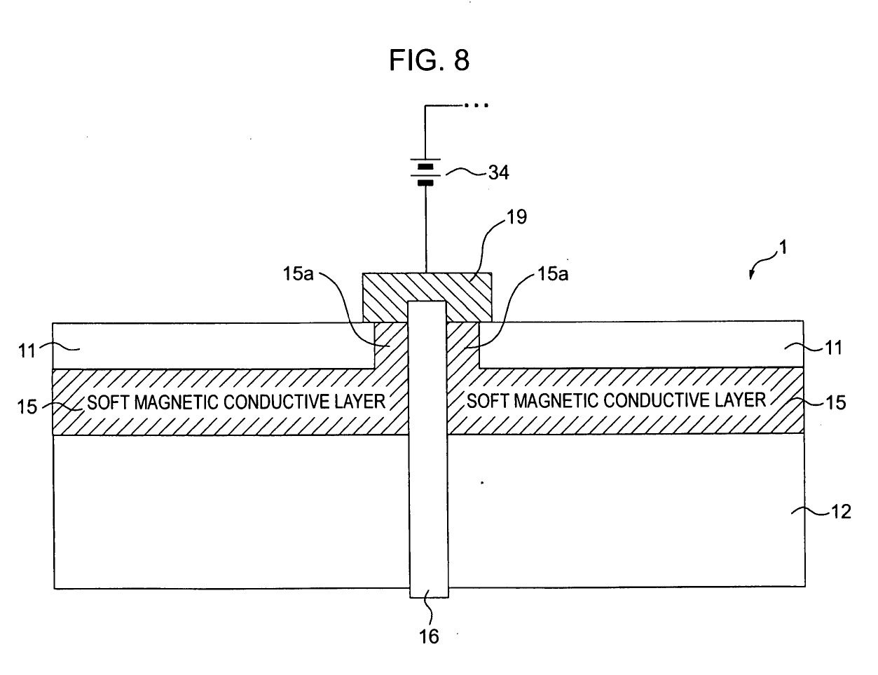

This connection can be realized as shown in FIG. 7 or FIG. 8.

FIG. 7 shows an example in which the conductive layer (soft magnetic conductive layer 15) and the exterior voltage source 34 are connected to each other with a shaft 16 of a spindle motor provided therebetween.

In this case, the shaft 16 of the spindle motor is formed of a conductive material such as a metal. In addition, an electrode 17 in contact with one end of the shaft 16 is provided so as to be connected to the voltage source 34. Furthermore, the soft magnetic conductive layer 15 is formed so as to be in contact with the shaft 16 of the motor.

By the structure described above, the potential of the conductive layer (soft magnetic conductive layer 15) can be determined by the exterior voltage source 34.

In addition, FIG. 8 shows an example in which the conductive layer (soft magnetic conductive layer 15) and the exterior voltage source 34 are connected to each other with a chucking member 19 provided therebetween. In this case, in the vicinity of the rotation shaft 16, the recording layer 11 provided on the soft magnetic conductive layer 15 is partly peeled away, and a portion 15a of the soft magnetic conductive layer 15 is formed so as to be exposed at the upper surface of the disc.

The chucking member (cap) 19 composed of a conductive material is in contact with the portion 15a exposed at the upper surface as described above and is connected to the voltage source 34, and as a result, the potential of the soft magnetic conductive layer 15 can be determined by the voltage source 34.

It should be understood by those skilled in the art that various modifications, combinations, sub-combinations and alterations may occur depending on design requirements and other factors insofar as they are within the scope of the appended claims or the equivalents thereof.

What is claimed is:

1. An information recording apparatus comprising:
a recording head generating magnetic fields having different directions in accordance with information;
a recording medium having a magnetic recording layer recording magnetizations in accordance with the magnetic fields; and
electric field generation means for generating an electric field in the magnetic recording layer when magnetic recording is performed for the magnetic recording layer by the recording head, the electric field generation means having a voltage source.

2. The information recording apparatus according to claim 1,
wherein the recording head is a longitudinal magnetic recording head having two magnetic pole layers which generate a leakage magnetic field, and
the two magnetic pole layers are formed as a first conductive portion and a second conductive portion, which are insulated from each other with an insulating portion.

3. The information recording apparatus according to claim 2,
wherein the two magnetic pole layers formed as the first conductive portion and the second conductive portion are connected to a positive electrode side and a negative electrode side, respectively, of the voltage source so that electric field generation means is formed.

4. The information recording apparatus according to claim 1,
wherein the recording head is a perpendicular magnetic recording head having a magnetic pole layer formed as a conductive portion, and
the recording medium further has a substrate and a conductive layer including a conductive material, the conductive layer being provided between the magnetic recording layer and the substrate.

5. The information recording apparatus according to claim 4,
wherein the magnetic pole layer formed as the conductive portion of the recording head and the conductive layer of the recording medium are connected to a positive electrode side and a negative electrode side, respectively, of the voltage source so that electric field generation means is formed.

6. The information recording apparatus according to claim 5,
wherein the recording head further has an electrode provided on the magnetic pole layer formed as the conductive portion, and
the magnetic pole layer is connected to the positive electrode side of the voltage source via the electrode.

7. The information recording apparatus according to claim 5,
further comprising an electrically conductive part,
wherein the conductive layer of the recording medium is in contact with the electrically conductive part, and
the conductive layer is connected to the negative electrode side of the voltage source via the electrically conductive part.

8. The information recording apparatus according to claim 7,
wherein the electrically conductive part is a rotation shaft which rotationally drives the recording medium.

9. The information recording apparatus according to claim 7,
wherein part of the conductive layer is exposed at the upper surface of the recording layer and is in contact with the electrically conductive part.

10. The information recording apparatus according to claim 2 or 4,
wherein the magnetic recording layer of the recording medium comprises a ferromagnetic material having a coercive force which is decreased by application of an electric field.

11. The information recording apparatus according to claim 10,
wherein the ferromagnetic material is a ferromagnetic insulating material or a ferromagnetic semiconductor.

12. The information recording apparatus according to claim 11,
wherein the ferromagnetic semiconductor is a ferromagnetic semiconductor including a non-magnetic compound semiconductor and magnetic ions which replace some of atoms forming the non-magnetic compound semiconductor.

13. The information recording apparatus according to claim 12,
wherein the ferromagnetic semiconductor is one of (In, Mn) As, (Ga, Mn) As, (Ga, Mn) N, (Zn, Co) O, (Zn, V) O, and (Zn, Cr) Te, in which (A, B) C represents a compound formed by replacing some of ions forming a compound AC with ions B.

14. The information recording apparatus according to claim 10,
wherein the magnetic recording layer has a laminate structure including a ferromagnetic semiconductor layer and a ferromagnetic recording layer provided in that order from the bottom.

15. The information recording apparatus according to claim 10,
wherein the magnetic recording layer has a laminate structure including a ferromagnetic semiconductor layer, a non-magnetic layer, and a ferromagnetic recording layer provided in that order from the bottom.

16. The information recording apparatus according to claim 14 or 15,
wherein the ferromagnetic recording layer includes one of a ferromagnetic compound containing a magnetic metal selected from Fe, Co, Ni, and Pt, and an alloy thereof.

17. The information recording apparatus according to claim 16,
wherein the ferromagnetic recording layer is an insulating layer or a semiconductor layer, each containing fine particles of the ferromagnetic compound or the alloy.

18. A method for recording information, comprising the step of:
generating an electric field in a magnetic recording layer of a recording medium when magnetic recording is performed for the recording medium having the magnetic recording layer by generating magnetic fields having different directions in accordance with information using a recording head, the magnetic recording layer recording magnetizations in accordance with the magnetic fields.

19. The method for recording information, according to claim 18,
wherein the recording head is a longitudinal recording head in which two magnetic pole layers generating a leakage magnetic field are separated with an insulating portion to form a first conductive portion and a second conductive portion,
the two magnetic pole layers are connected to a positive electrode side and a negative electrode side of a voltage source so as to generate an electric field between the two magnetic pole layers, and
a leakage electric field of the electric field is applied to the magnetic recording layer.

20. The method for recording information, according to claim 18,
wherein the recording head is a perpendicular recording head in which a magnetic pole layer is formed as a conductive portion,
the recording medium further has a substrate and a conductive layer including a conductive material, the conductive layer being provided between the magnetic recording layer and the substrate,
the magnetic pole layer formed as the conductive portion of the recording head and the conductive layer of the recording medium are connected to a positive electrode side and a negative electrode side, respectively, of a voltage source so as to generate an electric field between the magnetic pole layer and the conductive layer, and
the electric field generated therebetween is applied to the magnetic recording layer.

21. An information recording apparatus comprising:
a recording head generating magnetic fields having different directions in accordance with information;
a recording medium having a magnetic recording layer recording magnetizations in accordance with the magnetic fields; and
an electric field generation circuit for generating an electric field in the magnetic recording layer when magnetic recording is performed for the magnetic recording layer by the recording head, the electric field generation circuit having a voltage source.
